(19) United States
(12) Patent Application Publication
(10) Pub. No.: US 2013/0248742 A1
(43) Pub. Date: Sep. 26, 2013

(54) Digital Control Method for a Hydraulic ON/OFF Valve

(71) Applicants: Ingo Schepers, Lohr am Main (DE); Daniel Weiler, Niedernburg (DE)

(72) Inventors: Ingo Schepers, Lohr am Main (DE); Daniel Weiler, Niedernburg (DE)

(73) Assignee: Robert Bosch GmbH, Stuttgart (DE)

(21) Appl. No.: 13/428,669

(22) Filed: Mar. 23, 2012

(51) Int. Cl. F15B 13/044

(52) U.S. Cl. 251/129.05

(57) ABSTRACT

The disclosure relates to a digital control method for a hydraulic ON/OFF valve. The ON/OFF valve is controlled by a digital control signal. The digital control signal has a number of successive cycles. Each cycle of the number of successive cycles has a pulse lasting a variable pulse period and a pause lasting a variable pause period. The pause period (tₚ) of each cycle is set taking into account the time when the ON/OFF valve reaches the OFF state after the pulse of the cycle.

### FIELD OF THE INVENTION

The invention relates to a method for digitally controlling a hydraulic ON/OFF valve.

### Prior Art

The invention lies in the field of digital hydraulics. Digital hydraulics implies the usage of ON/OFF valves in a closed or open loop control for controlling an actuator (e.g. a piston of a main stage). A method for controlling an actuator using ON/OFF valves is disclosed in WO 02/086327 A1.

For ON/OFF valves digital control methods are common, because the ON/OFF valves have two steady states which can be compared with the “one” and the “zero” of the digital control methods. The most common digital control methods are the pulse width modulation (PWM) and the pulse frequency modulation (PFM). Like in all digital control methods just two levels exist represented by “one” and “zero”. During a pulse tᵢ the signal is on the high level and during a pause tₚ the signal is on a low level. When a signal is pulse frequency modulated the duration of the pulse tᵢ is fixed but the duration of the pause tₚ varies. When a signal is pulse width modulated the cycle duration (sum of pulse and pause) is fixed.

Typical for prior art digital control methods is the discontinuous movement of the actuator which is the result of the discontinuous volume flow which in turn is the effect of switching ON/OFF valves. It is desirable to avoid any discontinuity in the actuator movement.

### DISCLOSURE OF THE INVENTION

According to the invention a method for digitally controlling an ON/OFF valve according to the independent claim is provided. Advantageous embodiments are defined in the dependent claims.

### Advantages of the invention

The invention is based on the finding that the discontinuities in the movement of the actuator originate from the pauses in the control signal. This problem occurs especially with ON/OFF valves, since the switching times (time for state change) are relatively long and cannot be neglected. The typical PWM cycle durations must therefore be relatively long in order to account for switching times.

The invention achieves to minimize the pauses. It is impossible to simply decrease the cycle duration, because the switching times of the ON/OFF valves are too high for such small PWM cycle durations. The basis of the digital control method is to generate a digital control signal having a number of successive cycles, wherein each cycle consists of a pulse tᵢ with a specific pause tₚ so that the valve reaches the OFF state at the end of the pause tₚ. If a new pulse starts at this time the pause is minimized. By minimizing the pauses between pulses, the discontinuity of the actuator movement is reduced and speed and quality of control can be improved.

The invention is described in relation to the ON state and the OFF state of the valve, wherein the ON state is the actuated stated caused by a pulse and the OFF state is the normal state caused by a pause. In NC (normally closed) valves, the OFF state is the closed state; in NO (normally open) valves, the OFF state is the open state.

For long pulses the switching off time of an ON/OFF valve is nearly constant. So in this case the pause tₚ has the length of the switching off time. When the pulses are very short so that the piston cannot reach the end stop of the ON state the pause tₚ must be reduced. Otherwise the pause tₚ is not optimized. Thus, the time period of the pause is chosen so that the valve reaches the OFF state basically at the end of the pause. The resulting digital control method differs from usual PWM in that the sum of pulse and pause duration is not fixed, and differs from usual PFM in that the pulse duration is not fixed.

In order to account for a change of the fluid temperature, the fluid viscosity or the flow forces which could change the switching times of the ON/OFF valve, the used pause period tₚ′ could comprise the determined pause period tₚ and a robust parameter kᵣ, for example as a sum: tₚ′=tₚ+kᵣ. Thus, instabilities of the system could be avoided. The robust parameter will ensure that the valve always is in the OFF state at the end of the used pause period tₚ′.

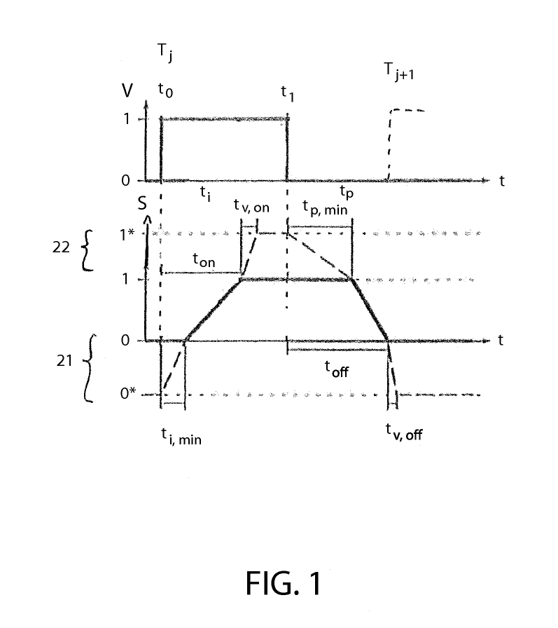

One preferred possibility to determine a pause period for a specific pulse period is based on a novel model to describe the dynamics of ON/OFF valves during fast switching control signals. This model is described under reference to FIG. 1.

Another preferred possibility to determine a pause period for a specific pulse period is based on a measurement of the piston stroke. E.g. the time when the piston reaches the OFF position can be measured.

By the digital control method according to the invention, one or more ON/OFF valves can be controlled as pilot valves, which in turn operate (e.g. movement or position control) a hydraulic actuator, e.g. a piloted valve, a linear or rotational hydraulic motor, a hydraulic (single-acting or double-acting) cylinder, a variable displacement pump or motor etc.

According to a preferred embodiment, a first group and a second group of ON/OFF valves are controlled, wherein the digital control signal for the second group has no pulse while the digital control signal for the first group has a pulse, and wherein the digital control signal for the first group has no pulse while the digital control signal for the second group has a pulse. Especially, the first group controls a movement of the actuator and the second group controls an opposite movement of the actuator. This allows for an improvement of speed and quality of control.

Each movement of the actuator can be operated by a number of ON/OFF valves. These ON/OFF valves can be controlled synchronously, i.e. having the pulses at the same time, or can be controlled with a time shift between the pulses. This allows for a reduction of discontinuities of the actuator movement and an improvement of speed and quality of control.

A computing unit according to the invention is, in particular programmatically, adapted to carry out an inventive method.

Also, the implementation of the invention in the form of software is advantageous because it allows particularly low costs, especially when a performing computing unit is still used for other tasks and therefore is present anyway. Suitable media for providing the computer program are particularly floppy disks, hard disks, flash memory, EEPROMs, CD-ROMs, and DVDs etc. A download of a program on computer networks (Internet, Intranet, etc.) is possible.

Further advantages and embodiments of the invention will become apparent from the description and the accompanying drawing.

It should be noted that the previously mentioned features and the features to be elucidated in the following are usable not only in the respectively indicated combination, but also in further combinations or taken alone, without departing from the scope of the present invention.

In the drawings:

FIG. 1 shows a relation between a piston stroke of an ON/OFF valve and a control signal according to a model underlying the invention.

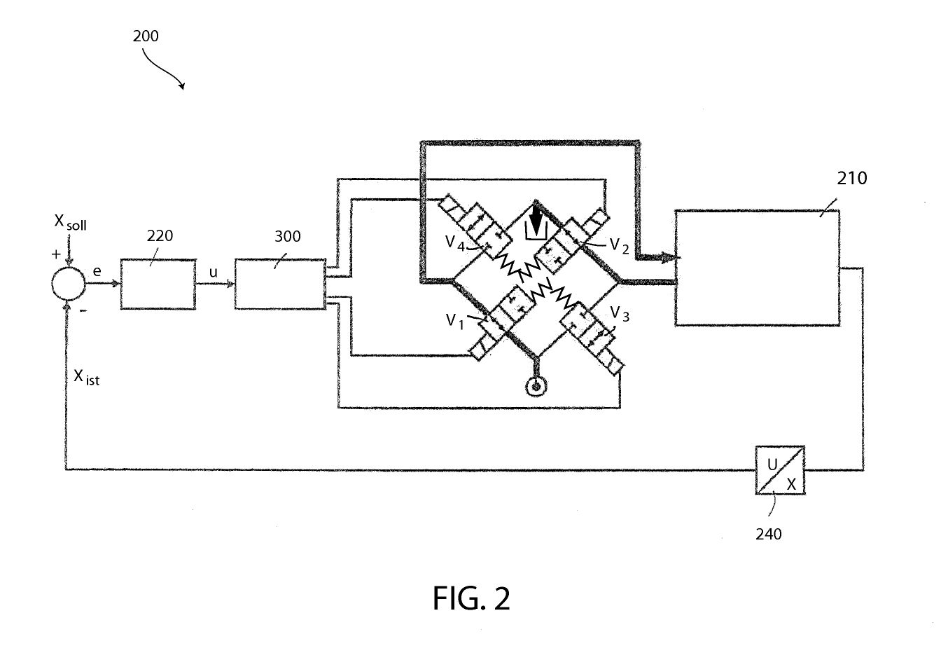

FIG. 2 schematically shows a hydraulic system comprising four ON/OFF valves for operating an actuator in a closed loop control.

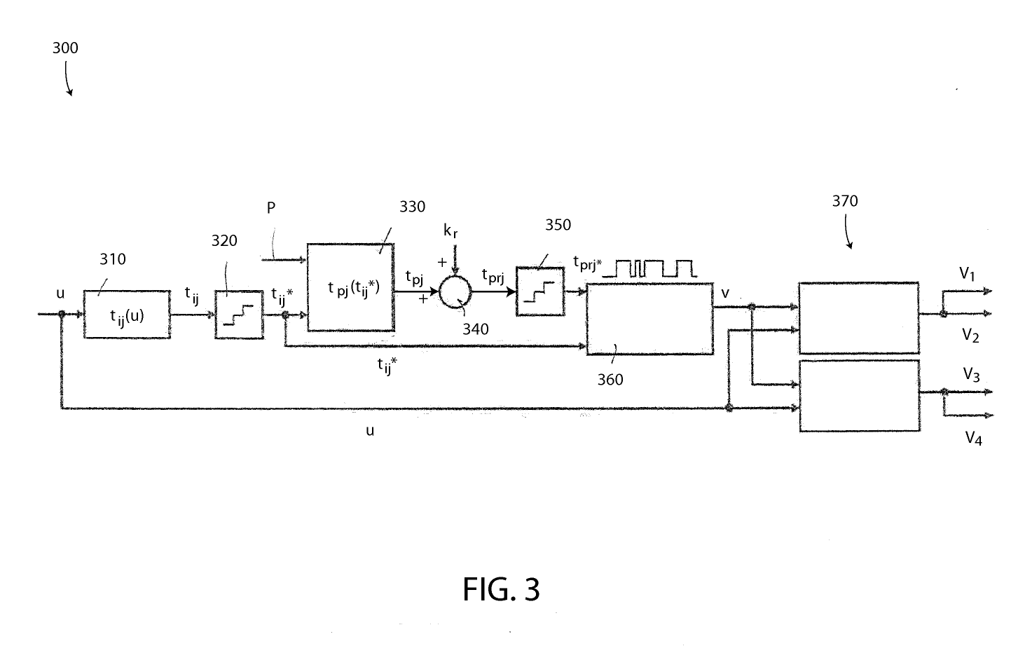

FIG. 3 schematically shows a preferred embodiment for the control structure of FIG. 2.

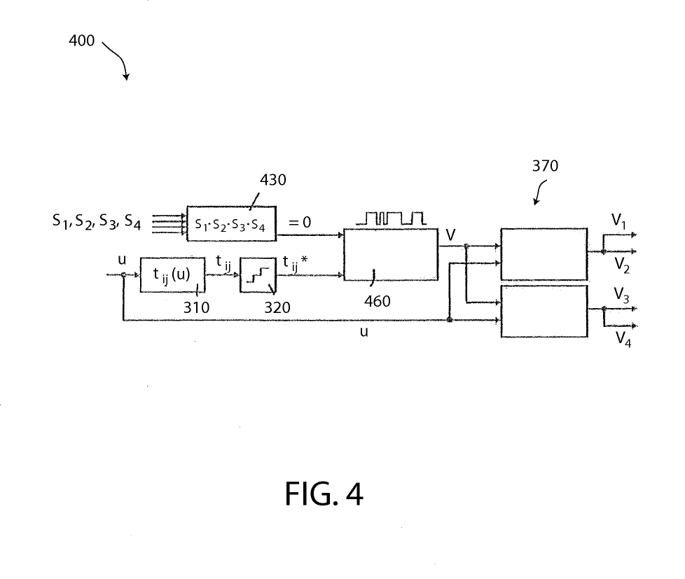

FIG. 4 schematically shows an alternative embodiment for the control structure in case the time when the ON/OFF valve reaches the OFF state is measured.

In FIG. 1 a relation between a piston stroke s of an ON/OFF valve and a digital control signal v according to a model underlying the invention is shown. The control signal v and the resulting stroke s are shown over time t. The control signal v has two successive cycles Tⱼ, Tⱼ₊₁. The first cycle Tⱼ has a pulse duration tᵢ and a pause duration tₚ.

The dynamics of the valve stroke from different kinds of ON/OFF valves basically show similar characteristics. One main effect of the valve dynamics is a time lag between the rising and falling edge of the control signal v and the beginning of the valve stroke s. In general this lag is not symmetrical but different for activation and deactivation. Short pulses or pauses of the control signal are completely suppressed by the valve, thus, the lag is no simple time delay. On the one hand the time lags which occur whenever the valve was fully activated or deactivated are independent from the width of the pulses and pauses of the control signal and therewith independent from the time the valve was in the activated (ON) or deactivated (OFF) state. On the other hand, if the control signal has its falling edge as soon as the valve is fully activated the time lag will be much smaller than in the case described above. The effects are mainly influenced by design parameters like spool or poppet mass, spring constant and spring preload or the orifice which controls the damping of the valve stroke but also by parameters which result in different solenoid forces like electric resistance, inductivity or voltage.

As shown in FIG. 1 the cycle start is referenced by Tⱼ. After the start of the pulse at t₀, the valve piston does not move for a constant time lag. This time lag is called ‘switching on delay’ t_{i,min}. After the duration t_{i,min} the piston motion starts sharply. The observations of switching valves show that the period of acceleration is in many cases very short, so that this period is neglected in the model. The velocity of the piston during the period of activating the valve is modeled to be constant. The time between the start of the pulse and time when the piston reaches the ON end stop (s=1) is called ‘switching on time’ tₒₙ.

On the other hand, the time between the end t₁ of the pulse and the piston starts to move to the OFF end stop is called ‘switching off delay’ t_{p,min} and the duration between the end t₁ of the pulse and the valve reaches the OFF end stop (s=0) is called ‘switching off time’ t_{off}. In order to minimize the pause period in line with the invention, the following pulse should start at Tⱼ₊₁ when the valve is in the OFF state.

To account for the fact that the piston stroke of small pulses is suppressed virtual ranges 21, 22 are implemented. Two virtual ranges exist, one virtual range 21 between the OFF end stop and a ‘virtual OFF end stop’ (s=0*) and one virtual range 22 between the ON end stop and a ‘virtual ON end stop’ (s=1*). In these virtual ranges no physical piston movement occurs. At the initial state (‘virtual OFF state’) the piston is at the virtual OFF end stop (s=0*).

During the period t_{i,min} the piston virtually moves with a constant velocity to the real OFF end stop (s=0) and reaches the real range after the time t_{i,min}. The chosen velocity for the virtual range and the duration t_{i,min} define the height of the virtual range 21. To complete the model an ‘additional switching off lag’ t_{v,off} is introduced to specify how fast the virtual OFF state is reached.

The same procedure is done for the virtual range 22 between the ON end stop and the virtual ON end stop. At the initial state (‘virtual ON state’) the piston is at the virtual ON end stop (s=1*). During the period t_{p,min} the piston virtually moves with a constant velocity to the real ON end stop (s=1) and reaches the real range after the time t_{p,min}. The chosen velocity for the virtual range and the duration t_{p,min} define the height of the virtual range 22. An ‘additional switching on lag’ t_{v,on} is introduced to specify how fast the virtual upper stop state is reached.

The model parameters P=(t_{i,min}, tₒₙ, t_{v,on}, t_{p,min}, t_{off}, t_{v,off}) which are needed for the model can be identified in different ways, for example by measurements. With the identification of the parameters by measurements a model validation is done in the same iteration. One possibility is to measure the piston stroke. With these measurements the parameters can be identified easily. The parameters can be identified not only by measurements but also by simulations of a more complex and validated existing CFD/FEM-model, for example.

An ON/OFF valve according to the model only opens when the pulse period tᵢ exceeds t_{i,min}. If a valve lag exists, i.e. if a movement of the piston does not immediately results in a hydraulic opening of the valve, operating the valve within the lag should be avoided. Thus, a minimum pulse period defined by t_{i,min}+t_{lag} is preferably provided which substitutes t_{i,min}. Thus, each control output of the closed loop control is converted into a pulse having at least a pulse period t_{i,min}+t_{lag}.

Based on the model above, a minimized pause period tₚ(tᵢ) depending on the preceding pulse period tᵢ can be calculated according the following method:

Control function S_{OPM}(t, tᵢⱼ, tₚⱼ) of the valve can have the two different values “1” and “0”, wherein t means the actual time, tᵢⱼ means the pulse period of cycle j and tₚⱼ means pause period of cycle j, Tⱼ means the start time of cycle j:

$${S}_{OPM} = \{ \begin{matrix}1 & f . {T}_{j - 1 } \leq t < {t}_{ij} + {T}_{j - 1} \\ 0 & f . {T}_{j - 1} + {t}_{ij} \leq t < {\underbrace{{t}_{ij} + {t}_{pj} + {T}_{j - 1}}}_{{T}_{j}}\end{matrix} \}$$

As mentioned above, the sum of tᵢ and tₚ for different cycles usually differs.

Based on this model, the preferred pause period tₚⱼ(tᵢⱼ) is calculated by:

$${t}_{pj} ( {t}_{ij} ) = \{ \begin{matrix}Δ t & f . {t}_{ij } < {t}_{i , min} ( + {t}_{lag} ) \\ \frac{{t}_{off} - {t}_{p , min}}{{t}_{on} - {t}_{i , min}} & f . {t}_{i , min} ( + {t}_{lag} ) \leq {t}_{ij} < {t}_{on} \\ ( {t}_{ij} - {t}_{on} ) \frac{{t}_{p , min}}{{t}_{v , on}} + {t}_{off} - {t}_{p , min} + {t}_{v , off} & f . {t}_{on} \leq {t}_{ij} < {t}_{on} + {t}_{v , on} \\ {t}_{off} + {t}_{v , off} & f . {t}_{on} + {t}_{v , on} \leq {t}_{ij}\end{matrix}$$

As mentioned above, the actually used pause period could comprise the determined pause period tₚⱼ(tᵢⱼ) and a robust parameter kᵣ. As one can see, a minimum pause period Δt is defined to avoid that a cycle period becomes zero.

In FIG. 2 a control loop 200 is shown schematically to illustrate a preferred embodiment of the invention. The control loop 200 includes four ON/OFF valves V₁-V₄ for operating an actuator 210. The actuator 210 may be for example, a piston or a main stage valve of a pilot-operated valve assembly.

A set-point value xₛₒₗₗ is compared with a feedback actual value xᵢₛₜ and a control error e is calculated therefrom. The control error e is transmitted to a control element 220, e.g. a proportional controller. The control element 220 calculates a control output u based on the control error e.

The control output u is transmitted to a calculating block 300 which is shown in more detail in FIG. 3. In the calculating block 300 a digital control signal v is generated according to a preferred embodiment of the invention. The digital control signal v is used to control the valves V₁-V₄.

The valves are connected in pairs, so either the valves V₁ and V₂ are open, while the valves V₃ and V₄ are closed, or vice versa. The actual position of the actuator is detected at 240 and feed back as the actual value.

Under reference to FIG. 3, a pulse period tᵢⱼ(u) is calculated based on the control output u in a block 310. This calculation is preferably made taking into account the minimum pulse period described above. Especially, a relation in the form of tᵢⱼ(u)=c·u+t_{i,min}+t_{lag} having a suitable slope c can be used.

In a block 320 the calculated pulse period tᵢⱼ(u) is quantized to tᵢⱼ* and transferred to a model block 330. The model block 330 includes the above described relation tₚⱼ(tᵢⱼ). Further, the mentioned parameters P are transferred to the model block 330.

Such calculated pause period tₚⱼ is combined with the robust parameter kᵣ to tₚᵣⱼ at 340 and quantized at 350.

Quantized pulse period tᵢⱼ and quantized pause period tₚᵣⱼ* are combined in 360 for generating a digital control signal v. In the digital control signal, a new pulse tᵢⱼ₊₁* starts immediately after the preceding pause period tₚᵣⱼ*.

The digital control signal v and the control output u are transmitted to block 370, in which the control signals for the ON/OFF valves V₁-V₄ are calculated. Which of the two pairs of valves is opened can be decided based on the sign of u. The chosen pair is then controlled with the digital control signal v. E.g. in case u is larger than zero, valves V₁ and V₂ are controlled, and in case u is less than zero, valves V₃ and V₄ are controlled.

Under reference to FIG. 4, an alternative embodiment 400 to the calculation of the pause period is based on a measurement of the piston stroke. In this embodiment, the time when the valve reaches the OFF position is measured and the following pulse is started when each valve V₁-V₄ is OFF. Signals S1-S4 representative of the piston strokes are transferred to a determination block 430. When each valve is OFF, a trigger signal is transferred to digital control signal generating block 460. This trigger signal defines the start of the pulse defined by pulse period tᵢⱼ*.

1. A digital control method for a hydraulic ON/OFF valve, comprising:
controlling the ON/OFF valve by a digital control signal,
wherein the digital control signal has a number of successive cycles,
wherein each cycle of the number of successive cycles has a pulse lasting a variable pulse period and a pause lasting a variable pause period, and
wherein the pause period of each cycle is set taking into account the time when the ON/OFF valve reaches the OFF state after the pulse of the cycle.

2. The digital control method according to claim 1, wherein the pause period of each cycle is set so that the ON/OFF valve reaches the OFF state at the end of the cycle.

3. The digital control method according to claim 1, wherein the pause period of each cycle is determined in dependence of the pulse period of the cycle.

4. The digital control method according to claim 1, wherein the time when the ON/OFF valve reaches the OFF state after the pulse of the cycle is measured or detected.

5. The digital control method according to claim 1, wherein the pause period of each cycle has at least a minimum pause duration.

6. The digital control method according to claim 1, wherein the pause period of each cycle is determined by accounting for a switching on time between the start of the pulse and the time when the valve reaches the ON state and/or a switching off time between the end of the pulse and the time when the valve reaches the OFF state.

7. The digital control method according to claim 1, wherein the pause period of each cycle is determined by accounting for a switching on delay between the start of the pulse and the time when the valve leaves the OFF state and/or a switching off delay between the end of the pulse and the time when the valve leaves the ON state.

8. The digital control method according to claim 6, wherein the pause period of a cycle is determined as the ratio of
a) the difference between the switching off time and the switching off delay, and
b) the difference between the switching on time and the switching on delay, when the pulse period of the cycle is between the switching on delay and the switching on time.

9. The digital control method according to claim 1, wherein the pause period of each cycle is determined by accounting for an additional switching on delay between the time when the valve reaches the ON state and the time when the valve reaches a virtual ON state and/or an additional switching off delay between the time when the valve reaches the OFF state and the time when the valve reaches a virtual OFF state.

10. The digital control method according to claim 6, wherein the pause period of a cycle is determined as the sum of the switching off time and the additional switching off delay, when the pulse period of the cycle is larger than the sum of the switching on time and the additional switching on delay.

11. The digital control method according to claim 6, wherein the pause period of a cycle is determined as the sum of
A) the product of
a) the difference between the pulse period of the cycle and the switching on time, and
b) the ratio of the switching off delay and the additional switching on delay,
B) the difference between the switching off time and the switching off delay, and
C) the additional switching off delay,
when the pulse period of the cycle is between the switching on time and the sum of the switching on time and the additional switching on delay.

12. The digital control method according to claim 1, wherein the pulse period of each cycle has at least a minimum pulse duration accounting for a valve lag.

13. The digital control method according to claim 1, wherein the pause period of each cycle is determined by adding a robust parameter to the time when the ON/OFF valve reaches the OFF state after the pulse of the cycle.

14. The digital control method according to claim 1, wherein:
a first group and a second group of ON/OFF valves are controlled,
the digital control signal for the second group has no pulse while the digital control signal for the first group has a pulse, and
the digital control signal for the first group has no pulse while the digital control signal for the second group has a pulse.

15. The digital control method according to claim 1, wherein:
a number of ON/OFF valves is controlled,
a predefined time shift is generated between the pulse of the digital control signal for a first ON/OFF valve of the number of ON/OFF valves and the pulse of the digital control signal for a second ON/OFF valve of the number of ON/OFF valves.

16. The digital control method according to claim 1, wherein a computing unit is, programmatically adapted to perform the digital control method.

17. The digital control method according to claim 1, wherein a computer program includes a program code means for causing a computer or a corresponding computing unit to perform a the digital control method, when executed on the computer or the corresponding computing unit.

18. A machine-readable storage medium having stored thereon a computer program comprising program code means for causing a computer or a corresponding computing unit to perform a digital control method for a hydraulic ON/OFF valve, when executed on the computer or the corresponding computing unit, the method comprising:
controlling the ON/OFF valve by a digital control signal,
wherein the digital control signal has a number of successive cycles,
wherein each cycle of the number of successive cycles has a pulse lasting a variable pulse period and a pause lasting a variable pause period, and
wherein the pause period of each cycle is set taking into account the time when the ON/OFF valve reaches the OFF state after the pulse of the cycle.
